(19) United States
(12) Patent Application Publication
(10) Pub. No.: US 2005/0243417 A1
(43) Pub. Date: Nov. 3, 2005

(54) Device for spatial modulation of a light beam and corresponding applications

(75) Inventors: Sebastien Massenot, Brest (FR); Raymond Chevallier, Plougonvelin (FR); Michel Barge, Milizac (FR); Jean-Louis De Bougrenet De La Tocnaye, Guilers (FR)

Correspondence Address: MERCHANT & GOULD PC, P.O. BOX 2903, MINNEAPOLIS, MN, 55402-0903, US

(73) Assignee: OPTOGONE, PLOUZANE (FR)

(21) Appl. No.: 11/100,267

(22) Filed: Apr. 5, 2005

(30) Foreign Application Priority Data
Apr. 15, 2004 (FR) 04 03967

(51) Int. Cl. G02B 27/26

(52) U.S. Cl. 359/465

(57) ABSTRACT

The invention relates to a device for spatial modulation of a light beam of the type including: a polymer dispersed liquid crystal (PDLC) element, comprising at least two pixels distributed in a matrix with two pixelisation axes and that can be addressed independently of each other using a system with at least two electrodes; optical means for reducing the sensitivity of the said device to polarisation of the incident light beam. According to the invention, the optical means comprise depolarisation means for depolarising the incident light beam on the said PDLC element.

### FIELD OF THE INVENTION

The field of the invention is optical telecommunications. More precisely, the invention relates to a liquid crystal based device for spatial modulation of light that is insensitive to polarisation of the incident light beam.

### SOLUTIONS ACCORDING TO PRIOR ART

Such devices, frequently called spatial light modulators, are key components of existing telecommunication systems. They can actually be used to perform dynamic attenuation or spatial phase shift functions of the light beam, for spectrum equalisation or channel equalisation purposes (as mentioned in European patent No. EP1207418 document or French patent application documents No. 0315594 and No. 0301699) or beam shaping, or for obtaining variable delay lines or tuneable filters (as mentioned in European patent document No. EP09036152A).

Several types of modulators are already known capable of performing these different functions, but among these different types, this invention is related more particularly to light modulators including a liquid crystal and composite liquid crystal based element used to attenuate or shift the phase of all or part of the light beam.

Some of these modulators use a voltage controlled liquid crystal cell such that the voltage applied to the terminals of the cell makes the phase of light passing through it vary by rotation of the optical axis of the liquid crystal, from a direction parallel to the direction of propagation of light to a perpendicular direction or vice versa. For example, this type of effect is used in optical attenuator presented in international patent application No. WO 02/071133 A2 in the name of XTELLUS Inc.

These liquid crystal modulators may also include a system of electrodes (in the form of strips or matrices) used to independently address some parts of the liquid crystal based material as indicated in American patent document No. U.S. Pat. No. 6,285,500.

Thus, if liquid crystal is used, the anisotropic phase modulation of the material is used by the electric field and the component is naturally sensitive to polarisation. Some configurations (particularly for the choice of materials or alignment conditions) can make the liquid crystal insensitive to polarisation as described in international patent application document No. WO098/06192.

New modulator types have recently been developed in which the liquid crystal element was replaced by an element containing a liquid crystal and polymer mix, called PDLC (Polymer Dispersed Liquid Crystal) and will be referred to as a PDLC cell in the remainder of this description.

In the usual configuration of a spatial light modulator, in other words when the electric field applied to the PDLC material is collinear with the optical wave vector, this type of device may be considered as being practically insensitive to polarisation if the number, size and shape of the elementary diffusers (in other words liquid crystal droplets) are chosen correctly.

This property of insensitivity to polarisation of incident light becomes very important in the telecommunications field, for which a low Polarisation Dependent Loss (PDL) is usually required as indicated in European patent document No. EP1207418.

Consider a PDLC cell divided into a plurality of elementary areas, or pixels distributed in a matrix that can be addressed independently using an appropriate system of electrodes. For a matrix larger than one line and larger than one column, two pixelisation axes can be defined corresponding to directions along which pixels are distributed. In the case of a single line or a single column matrix called a strip, it is only possible to define one pixelisation axis in this way, but a second pixelisation axis is defined artificially corresponding to the direction orthogonal to the first axis.

The property of insensitivity to polarisation is usually achieved in the central region of each elementary pixel but not in regions between pixels.

The difference in relative potential between two addressed adjacent pixels generates transverse electric fields, which have the effect of giving a preferred orientation to liquid crystal droplets, perpendicular to the optical wave vector and for which the orientation cannot be controlled.

Obviously this phenomenon depends on relative voltages between the different pixels in the cell, and the thickness and dimension of the inter-pixel area.

If elementary areas of the cell cannot be blocked off (which is the case for example when the modulator is used for continuous attenuation of the optical signal, in which case the light signal illuminates the entire modulator rather than each pixel individually), the effect of this phenomenon is to reintroduce parasite macroscopic optical anisotropy which causes an increase in the global PDL and makes the modulator incompatible with the constraints of modern optical telecommunication systems.

This phenomenon of sensitivity to the polarisation of incident light may also occur in the useful region of a pixel when the pixel size is small compared with the size of the inter-pixel region; in this configuration, the effects of the electric field created on a pixel are significant sensitive on the adjacent pixel even beyond the actual area between pixels.

This unwanted phenomenon caused by the creation of transverse electric fields is presented in more detail with reference to FIG. 1.

Consider a spatial light modulator comprising two glass plates, one covered by a counter electrode 10 and the other by a network of transparent electrodes 12 between which a PDLC type material 13 is inserted. Each electrode can be used to apply a local addressing voltage to the material and an electric field is set up collinear with the wave vector of the light beam illuminating the modulator. Each electrode in the network is brought up to a specific potential, and so relative voltage variations are induced between the electrodes (for example electrodes references 14, 15 and 16), and transverse voltages are created illustrated in FIG. 1 by equipotential lines in areas 11 and 17.

It can be difficult to reduce these transverse voltages due to the variable modulation on the electrodes and the high threshold voltages of the PDLC. Due to the short distance between pixels, they induce transverse electric fields and contribute to introducing preferred orientations of liquid crystal droplets that introduce birefringence in the PDLC material. On average, this birefringence provides a means of defining two particular polarisation states that are approximately the pixelisation directions, which is why the component is sensitive to the polarization of incident light.

Two techniques are usually used to solve this problem of sensitivity to polarisation, and they are presented in patent application document No. FR0301699. These two techniques are applicable in the case of a liquid crystal based modulator, and also in the case of a PDLC based or nano-PDLC based modulator (defined below with reference to FIG. 4A).

The first technique is based on the use of a polarization diversity system illustrated in FIGS. 2A and 2B.

In transmission (see FIG. 2A), two linear birefringent crystals 211 and 212 are used (for example manufactured using calcite) installed head to foot, between which the spatial light modulator 22 and two half-wave plates 231 and 232 oriented at 45° from the pixelisation axes of the modulator 22 are inserted, at the modulator output and input respectively.

The first crystal 211 separates incident light according to two polarisation states 221 and 222. The first half-wave plate) 231 rotates the direction of polarisation 222 to make it collinear with the direction of polarisation 221. Thus, any input polarisation is transformed into two beams with the same polarisation and “artificially” sees an isotropic material.

This device has the advantage of balancing the two optical paths and therefore of eliminating losses related to Polarisation Mode Dispersion (PMD). The polarisation direction at the output is the direction of one of the specific states of the linear birefringent elements 211 and 212, namely a straight polarisation. For practical separation reasons, the beams must be collimated using a collimation device not shown at the input and output of the modulator 22.

In reflection (see FIG. 2B), the system uses a linear birefringent crystal 24 (with beam collimation), a half-wave plate 25 aligned on a refracted beam following the above principle and a fixed delay on the other beam to compensate for the difference in the length of the return optical path (not shown in FIG. 2B). A spatial light modulator 26 is then placed in front of a mirror 27.

The second technique is based on the use of a quarter-wave plate as illustrated in FIG. 3A. Thus, a quarter-wave plate 31 is used on the back face of a spatial light modulator 32, usually between a mirror 33 and the modulator 32. The specific axes of the quarter-wave plate are oriented at 45° from the pixelisation axes. The principle consists of averaging attenuations between crossings in the forward and return directions by rotating the polarisation of incident beams on the modulator. It is useful if the rotation is maximum for the two polarisations corresponding to the pixelisation axes, and therefore to orient the axes of the quarter-wave plate at 45° from the pixelisation axes (as described in patent document No. FR 0301699), so as to minimise the PDL between pixels.

As illustrated in FIG. 3B, a small angle prism 34 or a glass wedge is usually associated with the quarter-wave plate to minimise optical cavity effects generated by the mismatch of indices between the quarter-wave plate 31 and the components of the spatial modulator 32. These cavity effects cause an increase in the PDL since the optical cavity is partly formed by a birefringent element 31.

These two techniques can reduce the PDL resulting from the crossing through the modulator. However, they require that several optical elements should be introduced into the system which introduces additional losses and makes the system more complicated. These optical elements also introduce parasite cavity effects (multiple interference related to the interfaces of media with different indices into the system) that generate additional PDL.

### PURPOSES OF THE INVENTION

One particular purpose of the invention is to overcome these disadvantages according to prior art.

More precisely, one purpose of the invention is to provide a technique specific to PDLCs, for making a spatial light modulator with a very low PDL.

Another purpose of the invention is to use such a technique that generates fewer losses than systems according to prior art.

Another purpose of the invention is to implement such a technique that minimises parasite cavity effects and therefore further reduces the PDL.

Another purpose of the invention is to use such a technique that has a very low chromatic dependence.

Another purpose of the invention is to provide such a technique that is easy to use and inexpensive.

### ESSENTIAL CHARACTERISTICS OF THE INVENTION

These purposes, and others that will become clear later are achieved using a device for spatial modulation of a light beam of the type including:
a polymer dispersed liquid crystal (PDLC) element, comprising at least two pixels distributed in a matrix with two pixelisation axes and that can be addressed independently of each other using a system with at least two electrodes;
optical means for reducing the sensitivity of the said device to polarisation of the incident light beam.

According to the invention, the optical means comprise depolarisation means for depolarising the incident light beam on the PDLC element.

The sensitivity of the device to polarisation is caused by the development of at least one transverse electric field between the electrodes.

Thus, the invention is based on a quite new and inventive approach to a spatial light beam modulator with a low PDL.

According to one advantageous characteristic of the invention, the optical means also comprise repolarisation means for repolarising the light beam output from the said PDLC element.

According to one advantageous embodiment of the invention, the depolarisation means and the repolarisation means are included in the same depolarising/repolarising device.

Thus, a reduction in the sensitivity to polarisation is obtained by using a single depolarising device or depolariser that eliminates losses related to the introduction of several optical devices as in solutions according to prior art.

According to another advantageous embodiment of the invention, the depolarisation means are included in a first depolarising device and the repolarisation means are included in a second repolarising device.

Advantageously, the depolarisation means and/or the repolarisation means are included within the Fourier plane of at least one 4 f optical set-up.

Preferably, the 4 f optical set-up(s) comprise(s) two converging lenses.

According to a first preferred embodiment of the invention, the depolarisation means and/or the repolarisation means comprise at least one birefringent prism.

Advantageously, the depolarisation means and/or the repolarisation means include a first birefringent prism and a second isotropic prism.

According to one preferred characteristic of the invention, the first prism comprises a front face approximately parallel to the matrix, and the second prism is placed such that a back face of the first prism is facing a front face of the second prism.

Advantageously, the birefringent prism(s) include(s) two neutral axes oriented at 45° from the pixelisation axes.

The back face of the second prism and the plane containing the pixelisation axes may form a non-zero angle.

According to a second preferred embodiment of the invention, the depolarisation means include at least one sub-wavelength diffraction grating.

According to a first embodiment according to the invention, the optical means for reducing the sensitivity to polarisation also include a quarter-wave plate.

According to one advantageous characteristic of the invention, the optical means for reducing sensitivity to polarisation include two quarter-wave plates.

Advantageously, the quarter-wave plates are placed on each side of the PDLC element.

According to one advantageous characteristic of the invention, the optical means for reducing the sensitivity to polarisation also include means of attenuating interference phenomena due to parasite cavities associated with the quarter-wave plate(s).

Thus, there is a reduction in the PDL related to cavity interference effects.

Preferably, the attenuation means include a small angle prism.

Advantageously, the small angle prism is placed between the PDLC element and the quarter-wave plate or one of the quarter-wave plates.

According to one preferred characteristic of the invention, the quarter-wave plate(s) include(s) their own two axes oriented at 45° from the neutral axes of the birefringent prism(s).

According to a second embodiment according to the invention, the optical means for reducing the sensitivity to polarisation also comprise a polarisation diversity system.

Preferably, the polarisation diversity system includes means of separating polarisations and means of rotating the polarisation.

Advantageously, the spatial modulation device operates in reflection.

According to one advantageous embodiment of the invention, the liquid crystal is of the nano-PDLC type, the liquid crystal droplets dispersed in the polymer having a diameter between approximately 10 nm and 100 nm.

The invention also relates to applications of the spatial modulation device as described above, that can be used for one of the following purposes:
attenuation of a light beam;
at least partial phase shift of a light beam;
spectrum equalisation;
light beam shaping;
design of variable delay lines;
design of tuneable filters;
selection of spectral bands;
optical add drop multiplexers (OADM).

### LIST OF FIGURES

Other specific features and advantages of the invention will become clearer after reading the following description of a preferred embodiment given as a purely illustrative and non-limitative example, and the appended figures, wherein:

FIG. 1 illustrates the phenomenon of creating transverse electric fields in the inter-electrode zones of a PDLC cell;

FIGS. 2A and 2B are diagrams of a modulation device made from a PDLC cell like that shown in FIG. 1 and including a polarisation diversity system in transmission (FIG. 2A) and in reflection (FIG. 2B) according to prior art;

FIGS. 3A and 3B are diagrams of a modulation device in reflection including quarter-wave plates according to prior art;

FIGS. 4A and 4B show the operating principle of a PDLC type liquid crystal cell used in the modulation device according to the invention;

FIG. 5 illustrates a Cornu prism used as a depolariser;

FIG. 6 illustrates a depolariser with a birefringent prism according to the invention;

FIGS. 7A and 7B illustrate a light beam spatial modulator according to the first preferred embodiment of the invention;

FIGS. 8A to 8D illustrate operation of the wedge depolariser in the set-up in FIGS. 7A and 7B;

FIG. 9 illustrates a spatial light beam modulator according to a second preferred embodiment of the invention;

FIGS. 10A and 10B illustrate a spatial light beam modulator according to the third preferred embodiment of the invention.

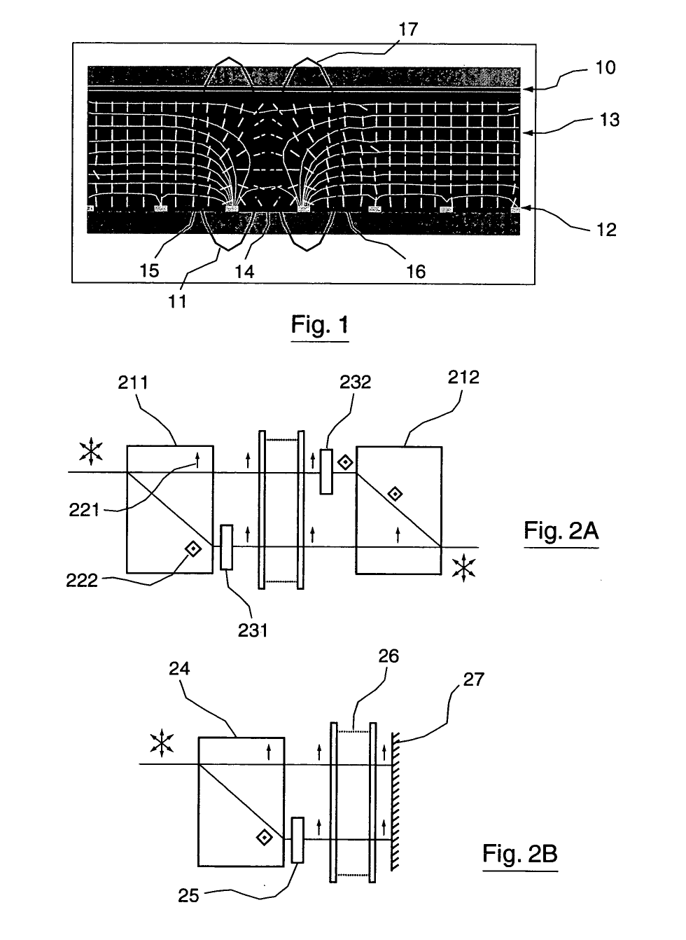

### DESCRIPTION OF AN EMBODIMENT OF THE INVENTION

The general principle of the invention is based on the use of a depolarising device, possibly associated with either one or several quarter-wave plates, or a polarisation diversity system in a spatial light modulator in order to reduce the PDL due to parasite transverse anisotropy generated by an inter-pixel field.

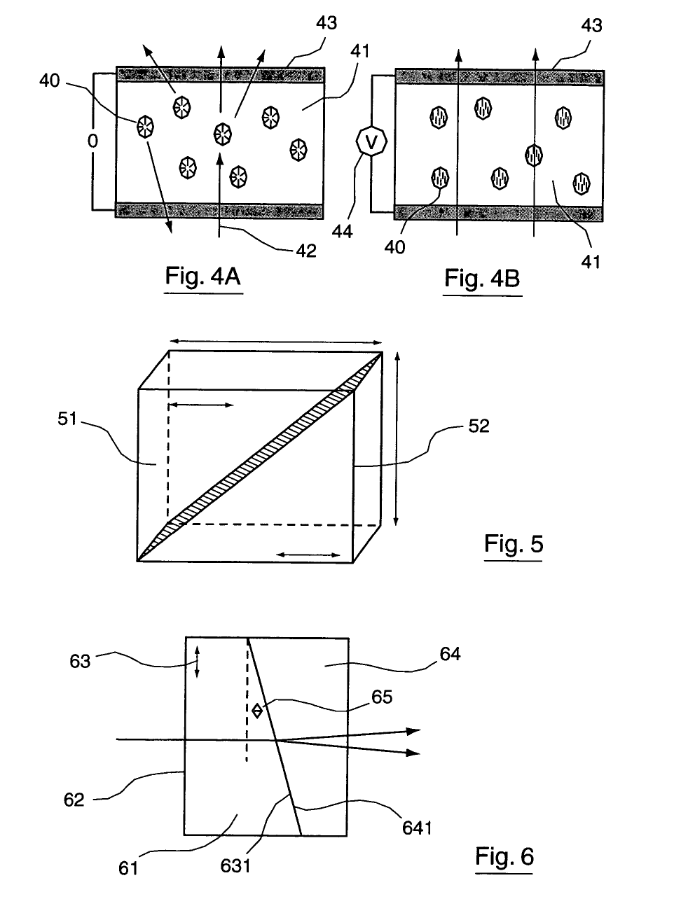

The operating principle of a PDLC cell or a PDLC element like that used in a spatial modulator of a light beam according to the invention, is presented with reference to FIGS. 4A and 4B. Liquid crystal droplets 40 are formed within a host polymer material 41. At rest (FIG. 4A), when no electric field is applied to the terminals of the cell, the orientation of these droplets within the polymer is arbitrary. Due to the difference between the index of the liquid crystal seen by the light beam (that depends on the orientation of liquid crystal droplets, the polarisation of the beam and the ordinary and extraordinary indices of the liquid crystal) and the index of the polymer, the light 42 that passes through the cell 43 passes through a multitude of diffusers or if the droplets are small compared with the wavelength of light (typically from 10 nm to 100 nm, in this case the term nano-PDLC is used), a multitude of retarders as illustrated by the arrows in FIG. 4A.

When a voltage 44 is applied to the terminals of the cell (FIG. 4B), the liquid crystal droplets 40 are aligned in the electric field thus created. Only the ordinary index of the liquid crystal can then be seen by light 42; since this index is comparable to the index of the polymer, the medium becomes transparent as illustrated by the arrows in FIG. 4B.

Therefore, attenuation or phase shift effects of a light beam produced using such a PDLC cell use properties very different from those used in a conventional liquid crystal cell. The properties used in a PDLC cell are light diffusion or delay properties related to the presence of liquid crystal droplets or domains, rather than properties related to rotation of the optical axis of the material, as in conventional liquid crystal cells.

Voltage control of a PDLC cell is usually used through a system of electrodes organised in the form of strips or matrices capable of addressing some areas of the cell, or pixels, independently (particularly as described in French patent application No. FR03115594).

The remainder of the description presents a spatial light modulator according to a preferred embodiment of the invention. Such a spatial light modulator comprises a PDLC cell (like that described with reference to FIGS. 4A and 4B) comprising a plurality of pixels defined from a matrix of addressing electrodes and optical means of reducing the sensitivity to polarisation. The remainder of the description considers the case of spatial modulators operating in reflection, and those skilled in the art could easily implement the invention in any PDLC spatial modulator, or a modulator of this type operating in transmission.

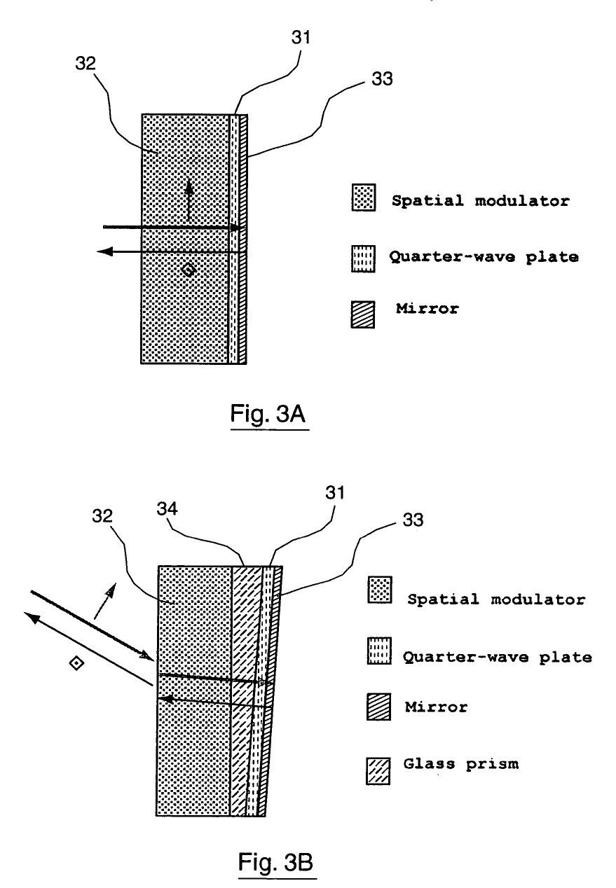

The general principle of operation of optical means for reducing the sensitivity of a spatial modulator to polarisation, according to the invention, is based on depolarisation of an incident light beam on the PDLC cell. And more particularly for light with one of the two polarisation states concerned by parasite anisotropy, itself generated by the transverse field. This technique cannot be used with pure liquid crystal. On the other hand, solutions according to prior art illustrated in FIGS. 3A and 3B use rotation of the polarisation of the two polarisation states mentioned above.

The optical means for reducing the sensitivity to polarisation of a spatial modulator according to one preferred embodiment of the invention include means of depolarising an incident light beam. These means are included in a depolarising device. Several depolarising devices are described below as examples, since the invention can be used with any type of depolarisation device.

A first depolarising device is the classical Lyot depolariser that consists of a combination of two birefringent plates cut parallel to their optical axes in which the neutral axes are oriented at 45° from each other (as indicated in the book by S. HUART entitled “Polarisation de la lumière” (Polarisation of light) published by MASSON in 1994).

The choice of an angle of 45° between the neutral axes of the two plates makes the combination independent of the input polarisation. On the other hand, this type of depolariser does not work in monochromatic light, depolarisation is only possible if the incident light beam has a sufficiently high spectral width. Each spectral component of the beam will be affected by a polarisation conversion, and there will be a superposition of polarisation states at the output from the component. The degree of polarisation will thus be reduced. In the context of gain equalisation or channel equalisation, the spectral widths involved cannot result in good depolarisation, unless an extremely large component is used which is incompatible with integration constraints usually required for this type of optical system.

A second depolarising device is the Cornu prism illustrated in FIG. 5. This prism includes two isosceles right angle half prisms, the first of which 51 is cut from the left quartz and the second 52 is cut from the right quartz. The optical axes of the two prisms are parallel to the direction of propagation (as described in the book by S. HUART entitled “Polarisation de la lumière” (Polarisation of light) published by MASSON in 1994).

If uniform illumination with size 2 d arrives on this component, depolarisation takes place if the condition ρd=π/4+kπ is true (where ρ is the specific rotational capacity of the material). For a material such as quartz, very large beams are necessary to satisfy this condition, and this would considerably increase the size of the system. Furthermore, such a component is sensitive to incident polarisation, therefore two components will have to be cascaded, in which the optical axes intersect each other, to eliminate this dependence. This increases the number of components and the final size of the system.

A third depolarising device is a sub-wavelength diffraction grating. Such a diffractive type device has only one diffracted order (the order zero) and can be considered as a birefringent medium. By writing a variable pitch diffraction grating, the wedge depolariser effect described above can be reproduced since there is a spatial variation of birefringence. Sub-wavelength structures with a continuous variation of periodicity have already been studied as described in patent application No. WO03025635. Concerning the depolariser function, a structure associating a variable quarter-wave plate and a variable half-wave plate can be used, which can eliminate dependence of the device on polarisation. Strong birefringences can thus be obtained because the component is computer designed. On the other hand, this type of grating must be designed so as to avoid the presence of diffraction anomalies (resonance phenomena) that are often present in sub-wavelength conditions. These anomalies result in sudden variations in the diffraction efficiency and correspond to coupling between an evanescent order of the grating and a guided mode of the structure. They are highly chromatic, a combination of plates enables an increase in the spectral range but at the price of a greater loss. Beam recombination may also be a problem.

Depolarisers based on diffractive elements such as sub-wavelength diffraction gratings require a very complex sizing. These depolarisers have strong chromatic dependences when they are used in resonance. The manufacture of such components would require etching at the electron beam and the smallest manufacturing defect would alter depolarisation.

A fourth depolarising device is made based on a birefringent prism and is illustrated in FIG. 6. It is called a wedge depolariser. Such a component comprises a first prism 61 that is birefringent (that can be made from any appropriate material) and for which the input face 62 is cut parallel to the optical axis 63 (that may be arbitrarily oriented in this plane). This first prism is associated with a second prism 64 composed of an isotropic material (for example made of silica, or glass, or any other appropriate material) used to compensate the prismatic deviation of the beams as well as possible. The two prisms 63, 64 are brought into contact such that a rear face 631 of the first prism is facing a front face 641 of the second prism.

Depolarisation for this type of component is spatial. Each spatial component of an incident beam will be subjected to a step difference, a beam with a well defined polarisation state at the input will be composed of a superposition of polarisation state at the output. We can see that unlike the Lyot depolariser, the birefringent wedge depolariser can operate with monochromatic or almost monochromatic light. A specific beam size is required to achieve maximum depolarisation. If the system already imposes the beam dimension, adjusting the angle of the prism or choosing a material with an appropriate birefringence can result in a different degree of polarisation. On the other hand, since the component thickness is not a critical parameter, it may be adapted to the size of the component in the system. It is useful to use it in the Fourier plane in which the optical beam is widened.

The formula for the degree of polarisation “DoP”, that quantifies the polarisation or depolarisation efficiency of an incident light beam with polarisation oriented at 45° from the neutral axes of the birefringent prism, by the wedge depolariser, is given as follows for uniform illumination:

$$dop = \vert sin c ( \frac{Δ nw π tan θ}{λ} ) \vert$$

where Δn is the birefringence of the prism, w the beam size, θ the angle of the prism 65 and λ is the wavelength of the incident beam.

If the direction of polarisation of the incident beam is parallel to the neutral axes of the birefringent prism, the beam output from the depolariser remains fully polarised and DoP=1. Finally, in the case in which the direction of polarisation of the incident beam forms an arbitrary angle with the neutral axes of the birefringent prism, the degree of polarisation DoP varies between 0 and 1.

It can be checked that the chromatic dependence of this depolarising device is low (0.03 dB over the entire telecommunication C band) and is better than for a half-wave plate and a polarisation diversity system using an element with high birefringence. On the other hand, this device has the disadvantage that it generates two output beams, due to the double refraction phenomenon. An appropriate material should be chosen to limit this phenomenon (for example quartz or any other appropriate material). Furthermore, pixels should be chosen to be sufficiently large so that the two beams can illuminate the same pixel, to assure that this is not a problem in the context of a spatial modulator according to the invention.

The response is sensitive to the polarisation state of the incident beam; if the input polarisation is aligned on the neutral axes of the prism, nothing happens (the polarisation state is not modified). To obtain a maximum depolarisation effect, the input polarisation must be oriented at 45° from the neutral axes of the birefringent prism.

The wedge depolariser can easily be adapted to an existing optical set-up by adjusting either the birefringence of the material or the prism angle θ. For a given beam size w, the degree of polarisation DoP depends on the product Δn.tan θ. Furthermore, theoretical modelling of this depolariser is fairly simple, so that simple formulas can be obtained for its design.

The aspect related to dependence on the input polarisation is not the biggest problem since the PDL is a maximum for a PDLC cell when working with polarisations parallel to and orthogonal to the pixelisation axes. All that is necessary is to orient the neutral axes of the depolariser at 45° from the pixelisation axes, so as to maximise depolarisation of these two states.

Another advantage of this depolarising device is that it is capable of repolarising the light beam output from the PDLC cell, thus it is a depolarising/repolarising device.

In a first preferred embodiment of a spatial modulator according to the invention, the means of reducing the sensitivity to polarisation of the modulator include a depolariser based on the combination of a birefringent prism and an isotropic prism like that described above.

Thus, in this embodiment, depolarisation means and repolarisation means are included in the same depolariser.

Other types of depolarising devices may be used in variants to this embodiment not illustrated, for example a sub-wavelength diffraction grating. In these variants, repolarisation means may be included in a repolarising device separate from the depolarising device. In other variants, those skilled in the art could use a spatial modulator without any repolarisation means.

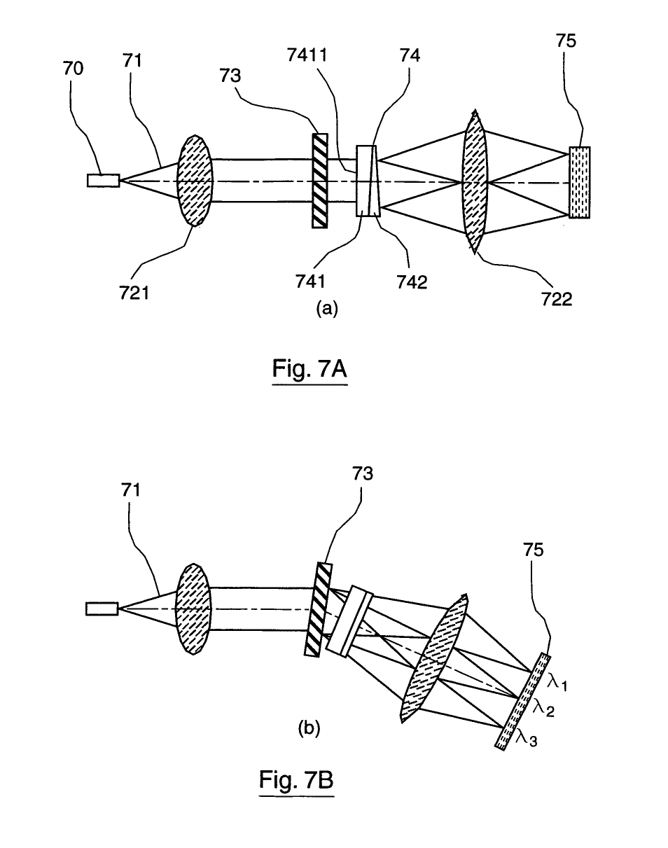

FIGS. 7A and 7B illustrate a spatial light beam modulator operating as a spectrum equaliser comprising means of reducing the sensitivity to polarisation according to a first preferred embodiment of the invention.

FIG. 7A is a diagram of a top view of the set-up of this modulator that includes an optical fibre 70 through which a light beam 71 is output comprising several wavelengths, a first convergent lens 721 collimates the beam 71, a diffraction grating 73 spatially separates the different lengths of the beam 71, a birefringent wedge depolariser 74 and a second convergent lens 722 that focuses the beam 71 on a PDLC cell 75 including a reflecting mirror (not illustrated) on its back face.

FIG. 7B is a diagram of a side view of the set-up in FIG. 7A. It can be seen that each sub-beam, corresponding to a wavelength of the beam 71 output from the diffraction grating 73, is diffracted at a different angle so that the different sub-beams are separated spatially before being treated selectively on the PDLC cell 75.

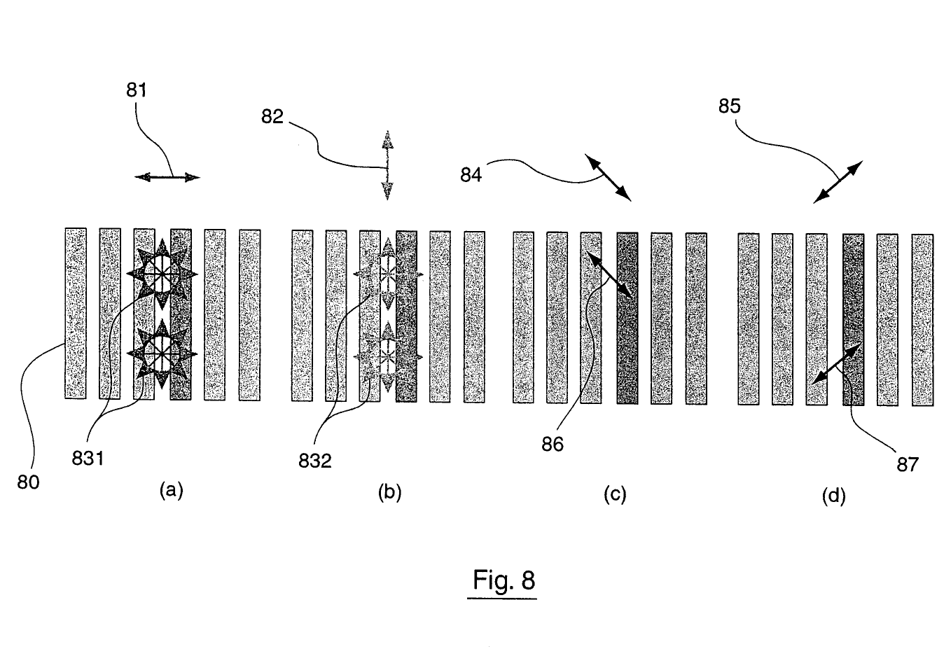

The depolariser 74 comprises a birefringent prism 741 for which the front face 7411 is approximately parallel to the matrix of the PDLC cell 75 and for which the neutral axes are oriented at 45° from the pixelisation axes of the PDLC cell 75. In this case, the appropriate choice of the angle of the birefringent prism 741 with respect to the plane formed by the pixelisation axes (in other words such that it can give a low value of the DoP parameter mentioned above—in practice, measured values of the order of 10⁻² are obtained) makes it possible to depolarise light beams 71 with a linear polarisation along a direction parallel to one of the pixelisation axes (see FIGS. 8A to 8D).

Preferably, the depolariser 74 is placed in the filter plane, or the Fourier plane, of a double diffraction set-up, or a 4 f optical set-up (formed by the two lenses 721 and 722). The beam is wider in this plane, and it can reduce the value of the dop parameter described above and therefore make it possible to benefit from greater depolarisation for a given prism angle. In other words, by working with a wider beam, beams with a linear polarisation along a direction parallel to one of the pixelisation axes can be completely depolarised, while limiting the prism angle. The fact of limiting the prism angle limits the deviation between the two output beams (the above mentioned double refraction phenomenon) of the depolariser 74, for all incident polarisations on the depolariser 74.

FIGS. 8A to 8D illustrate operation of the wedge depolariser 74 in the set-up in FIGS. 7A and 7B in the case in which the PDLC cell 75 is a pixel strip 80.

When the polarisation direction 81 or 82 of the light beam 71 at the input to the depolariser 74 is parallel to a pixelisation axis (FIGS. 8A and 8B respectively) the beam 71 is separated at the output from the depolariser into two completely depolarised beams 831 and 832 respectively.

When the light beam 71 at the input to the depolariser 74 has a polarisation direction 84 or 85 that forms an angle of 45° with one of the pixelisation axes of the PDLC cell 75 (FIGS. 8C and 8D respectively), the depolariser output beam 71 keeps its own polarisation direction, 86 or 87 respectively.

Since the spatial modulator of FIGS. 7A and 7B operates in reflection, the light beam 71 is repolarised through the depolariser 75 after reflection on the PDLC cell and before injection in the fibre 70.

In a second preferred embodiment of a spatial modulator according to the invention, the means of reducing the sensitivity to polarisation of the modulator include a combination of a birefringent wedge depolariser such as the depolariser 74 in FIGS. 7A and 7B and a polarisation diversity system like that described with reference to FIGS. 2A and 2B.

The use of a birefringent wedge depolariser alone cannot completely depolarise an incident light beam except for beams for which the linear polarisation is oriented at 45° from the neutral axes of the depolariser.

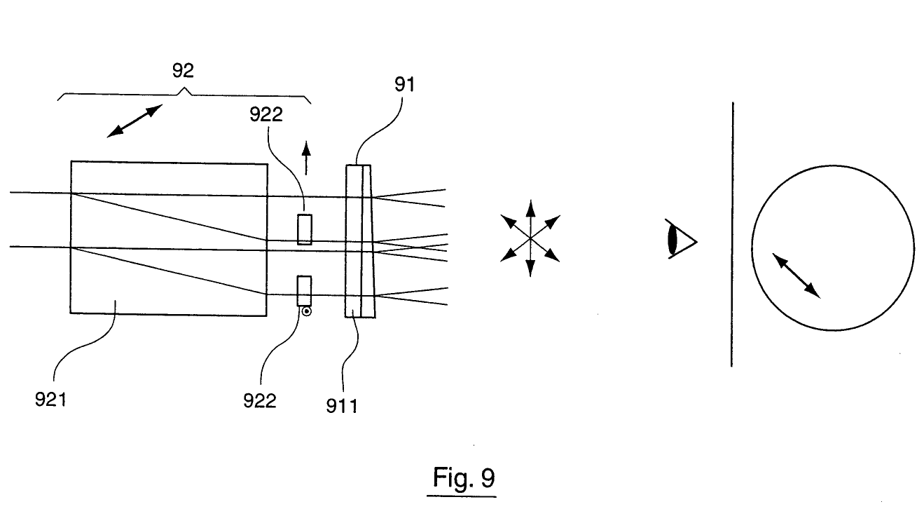

FIG. 9 illustrates such a combination of a birefringent wedge depolariser 91 and a polarisation diversity system 92 comprising a linear birefringent prism 921 and half-wave plates 922. The depolariser 91 includes a birefringent prism 911 for which the neutral axes are offset by 45° from the pixelisation axes of the PDLC cell. The axes of the birefringent crystal 921 of the polarisation diversity system are offset by 45° from the axes of the prism 911 of the depolariser.

Thus, a polarisation diversity system comprising a birefringent crystal is combined so as to separate the two polarisation states along the pixelisation axes of the PDLC cell, a half-wave plate rotating one of the two polarisations and a depolariser for which the axes are oriented at 45° from the axes of the birefringent crystal. In doing this, it is possible to completely depolarise the incident light on the SLM, regardless of the polarisation of light at the input to the system. Compared with a polarisation diversity system or a depolariser alone, the method can significantly reduce multiple interference effects that can occur inside the PDLC modulator caused by differences of indices between the different components of the modulator. If a depolariser is used alone, these multiple interferences can cause PDL directly, since the light is polarised on the modulator to a greater or lesser extent depending on its input polarisation state.

In a third preferred embodiment of a spatial modulator according to the invention, the means of reducing the sensitivity to polarisation of the modulator include a combination of a birefringent wedge depolariser such as the depolariser 74 in FIGS. 7A and 7B and two quarter-wave plates.

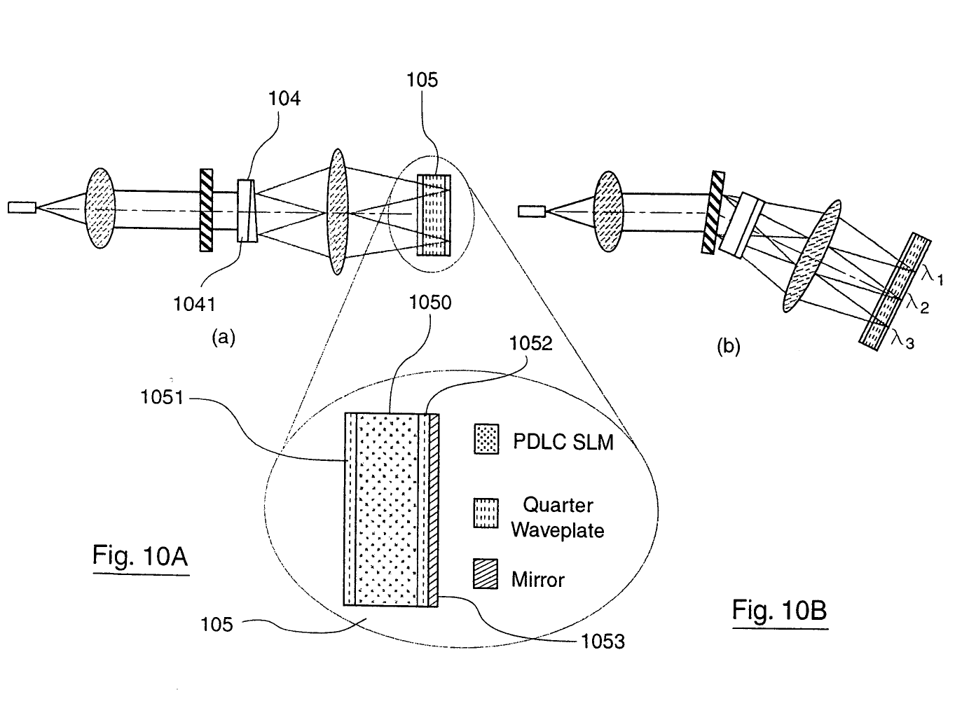

FIGS. 10A and 10B illustrate such a spatial light beam modulator operating as a spectrum equaliser operating in reflection.

The modulator in FIGS. 10A and 10B is identical to the modulator in FIGS. 7A and 7B, the only difference being that it comprises a global PDLC cell 105 itself including two quarter-wave plates 1051 and 1052.

The global cell 105 comprises a PDLC cell 1050 similar to the cell 75 described with relation to FIGS. 7A and 7B, a first quarter-wave plate 1051, a second quarter-wave plate 1052 and a mirror 1053, the mirror reflecting incident light beams on the cell 105.

The mirror 1053 may be a metallic mirror (deposition of a metal), a dielectric mirror (deposition of thin layers of dielectric materials providing good reflectivity) or any other type of mirror. The advantage of the metallic mirror is that it can act both as a mirror and as an electrode. Gold is a good metallic mirror (high reflectivity) for applications in the near infrared (wavelengths used in telecommunication), and minimises insertion losses of the system.

As in the case of the set-up in FIGS. 7A and 7B, the depolariser 104 includes a birefringent prism 1041 for which the neutral axes are oriented at 45° from the pixelisation axes of the PDLC cell 1050. The specific axes of the quarter-wave plates 1051 and 1052 are offset by 45° from the neutral axes of the birefringent prism 1041.

The advantage of this third embodiment is that, it makes it possible to transform the polarisation directions parallel to the axes of the depolariser 104 into circular polarisations at the crossing of the first quarter-wave plate 1051. The second quarter wave-plate 1052 transforms the circular polarisations into an orthogonal state, which means that multiple interference effects that could occur in the spatial modulator are cancelled, since beams that can interfere are polarised orthogonally. Therefore this correspondingly minimises the PDL due to these effects. Since spatial modulators operate in reflection, light is completely repolarised at the crossing through the depolariser before coupling in the input/output fibre.

According to one variant of this third embodiment according to the invention, a global cell 105 can be used also including a small angle prism placed between the PDLC cell 1050 and the second quarter-wave plate 1052 to minimise optical cavity effects generated by differences in the indices of the cell 1050 and the quarter-wave plate 1052.

Those skilled in the art could easily adapt the polarisation sensitivity reduction means according to the invention to spatial light beam modulators operating in transmission. For example such a modulator may include a depolarising device placed between an input fibre and a PDLC cell and a repolarising device placed between the PDLC cell and an output fibre. According to one preferred embodiment not shown, the depolarising device and the repolarising device are two birefringent wedge depolarisers. According to one variant of this embodiment, the depolarising device is a sub-wavelength diffraction grating and the repolarising device is a fibre depolariser.

Spatial light beam modulators according to the invention can be used for one of the following purposes:
attenuation of a polarised light beam;
at least partial phase shift of a polarised light beam;
spectrum equalisation;
shaping of polarised light beams;
design of variable delay lines;
design of tuneable filters;
selection of spectral bands;
optical add drop multiplexers (OADM).

These devices may also be used in any other application requiring modulation of polarised light beams.

1. Device for spatial modulation of a light beam of the type including:
a polymer dispersed liquid crystal (PDLC) element, comprising at least two pixels distributed in a matrix with two pixelisation axes and that can be addressed independently of each other using a system with at least two electrodes;
optical means for reducing the sensitivity of the said device to polarisation of the incident light beam,
wherein the said optical means comprise depolarisation means for depolarising the incident light beam on the said PDLC element.

2. Device according to claim 1, wherein the said optical means also comprise repolarisation means for repolarising the light beam output from the said PDLC element.

3. Device according to claim 1, wherein the said depolarisation means and the said repolarisation means are included in the same depolarising/repolarising device.

4. Device according to claim 1, wherein the said depolarisation means are included in a first depolarising device and the said repolarisation means are included in a second repolarising device.

5. Device according to claim 2, wherein the said depolarisation means and/or the said repolarisation means are included within the Fourier plane of at least one 4f optical set-up.

6. Device according to claim 5, wherein the said 4f optical set-up(s) comprise(s) two converging lenses.

7. Device according to claim 1, wherein the said depolarisation means and/or the said repolarisation means comprise at least one birefringent prism.

8. Device according to claim 7, wherein the said depolarisation means and/or the said repolarisation means include a first birefringent prism and a second isotropic prism.

9. Device according to claim 8, wherein the said first prism comprises a front face approximately parallel to the said matrix, and the said second prism is placed such that a back face of the said first prism is facing a front face of the said second prism.

10. Device according to claim 7, wherein the said birefringent prism(s) include(s) two neutral axes oriented at 45° from the said pixelisation axes.

11. Device according to claim 1 wherein the said depolarisation means include at least one sub-wavelength diffraction grating.

12. Device according to claim 1, wherein the said optical means for reducing the sensitivity to polarisation also include at least one quarter-wave plate.

13. Device according to claim 12, wherein the said optical means for reducing sensitivity to polarisation include two quarter-wave plates.

14. Device according to claim 13, wherein the said quarter-wave plates are placed on each side of the said PDLC element.

15. Device according to claim 12, wherein the said optical means for reducing the sensitivity to polarisation also include means of attenuating interference phenomena due to parasite cavities associated with the said quarter-wave plate(s).

16. Device according to claim 15, wherein the said attenuation means include a small angle prism.

17. Device according to claim 16, wherein the said small angle prism is placed between the said PDLC element and the said quarter-wave plate or one of the said quarter-wave plates.

18. Device according to claim 12, wherein the said quarter-wave plate(s) include(s) their own two axes oriented at 45° from the said neutral axes of the said birefringent prism(s).

19. Device according to claim 1, wherein the said optical means for reducing the sensitivity to polarisation also comprise a polarisation diversity system.

20. Device according to claim 19, wherein the said polarisation diversity system includes means of separating polarisations and means of rotating the polarisation.

21. Device according to claim 1, wherein it operates in reflection.

22. Device according to claim 1, wherein the said liquid crystal is of the nano-PDLC type, the droplets of the said liquid crystal dispersed in the said polymer having a diameter between approximately 10 nm and 100 nm.

23. Applications of the device according to claim 1, that can be used for one of the following purposes:
attenuation of a light beam;
at least partial phase shift of a light beam;
spectrum equalisation;
light beam shaping;
design of variable delay lines;
design of tuneable filters;
selection of spectral bands;
optical add drop multiplexers (OADM).
